(19) United States
(12) Patent Application Publication
(10) Pub. No.: US 2013/0006853 A1
(43) Pub. Date: Jan. 3, 2013

(54) ENTERPRISE SYSTEM, METHOD AND COMPUTER PROGRAM PRODUCT FOR AGGREGATING AND PRO RATING EXPENSES ACROSS MEMBERS OF A NETWORKED VIRTUAL COLLECTIVE

(76) Inventor: Christopher David Amundsen, North Salt Lake, UT (US)

(21) Appl. No.: 13/171,219

(22) Filed: Jun. 28, 2011

(51) Int. Cl. G06Q 40/00

(52) U.S. Cl. 705/40

(57) ABSTRACT

A computer program product, system and method are disclosed for aggregating expenses incurred by members of a group of commonly acquainted parties (the parties comprising individuals, entities, or organizations), and for collecting pro rated funds from each member. The parties are brought into communication by a computerized central managing forum, communicating via a network, which acts as a fiduciary of the parties and uses a uniquely configured data processing device which prompts the interconnected parties to remit pro rated payments of digitized bills stored and made digitally available by the central managing forum to the parties. Additional embodiments of the invention include a uniquely configured classified listing service, and notification service for special consumer offers.

### BACKGROUND OF THE INVENTION

1. Field of the Invention

This invention relates to online banking, and more particularly relates to a method, system and computer program product for managing, collecting and distributing expenses incurred by socially networked members of a group from one another, and facilitating efficient commercial transactions between them, including transaction arising from classified ads and discount coupon offers.

2. Description of the Related Art

Recent developments in the industry of banking and classified advertising include business models such as eBay®, PayPal®, FaceBook®, and Groupon®. Each of the websites managed by these organizations bring networked individuals into contact with another for the purpose of marketing goods and/or services, and/or effectuating financial transactions between them.

Although developments in the art teach means of billing and collecting debts incurred by consumers in commercial transactions, these developments do not teach efficient means of billing commonly-acquainted, socially networked members of a group for their respective pro rata shares of expenses benefiting the group as a whole, nor do presently existing models teach means of facilitating the reimbursement of expenses fronted by one individual of group from associated third-parties.

Furthermore, those online business that archive searchable classified ads, and those that market time-limited discount offers, do not provide integrated means of effectuating payment for contracts made between consumers. Rather, these sites redirect consumers to third-party sites which handle the payment transfers, such as PayPal®.

There exists a need in the industry for a fully integrated model. The present invention discloses means of aggregating bills tendered to members of a group of commonly acquainted parties (the parties comprising individuals, entities, or organizations), then of billing and collecting pro rated funds from each member of the collective. Additional embodiments of the invention include a uniquely configured classified listing service, and notification service for special consumer offers.

### SUMMARY OF THE INVENTION

From the foregoing discussion, it should be apparent that a need exists for an enterprise system, method and computer program product for aggregating and pro rating expenses across members of a networked virtual collective. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide an enterprise system and computer program product for aggregating and pro rating expenses across members of a networked virtual collective.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention discloses a computer program product comprising a computer readable medium having computer usable program code executable to perform operations for distributing expenses to a commonly-acquainted collective. The operations of the computer program product comprise: incorporating a plurality of members into a virtual collective by storing voluntarily uploaded personal information for each member in computer readable memory, the personal information comprising one or more of name, email address, phone number, and banking information; receiving a payment request uploaded into computer readable memory from one member of the collective for an expense via a network; and dividing the expense pro rata among the members of the collective.

The operations further comprise prompting electronically via the network each member of the collective to pay a pro rata share of the expense; receiving an electronic payment of a pro rata share from each of a plurality of the members of the collective; maintaining a running tally of payment amounts received from members of the collective; notifying each member via the network of the collective of the gross total of collective payments received which are associated with the expense; and reminding non-paying members of the user group to pay.

In some embodiments, the operations further comprise remitting all payments received and associated with the expense to the member uploading the payment request. In still further embodiments, the operations further comprise creating a sub-collective comprising a plurality of the members, each of the members of the sub-collective associated with one of: a common commercial venture and a common recreational activity.

In other embodiments, the operations further comprise maintaining a banking account balance for each member of the collective, the balance exclusively accessible by a member of the collective associated with the balance.

In some embodiments, the network comprises a wireless cellular network, while in other embodiments, each of the members are notified via one of computer terminal and a smart cellular phone.

In additional embodiments, the operations further comprise receiving a classified ad from a member via an upload, the classified ad comprising one or more of a picture of a tangible good and contact information for the member, the contact information comprising one or more of name, email address, and telephone number; providing a searchable database of all classified ads received by members; and facilitating the transfer of money between the member uploading the classified ad and a purchaser.

In still further embodiments, the operations further comprise: receiving a discount offer via an upload from a member, the discount offer comprising one or more of an offer to sell a consumer good exclusively to members, the offer comprising a price that is less than a price charged to non-members, the price exclusively available to members; allowing members to purchase the consumer good for the price; and transferring money from a member buying the consumer good to a member responsible for the upload.

In some embodiments, each of the members may be assigned a pay percentage value, the pay percentage value identifying the percentage of the expense for which each respective member is responsible.

A system to perform operations for distributing expenses to a commonly-acquainted collective is also disclosed, the system comprising: a processor; a data storage means for storing data; an incorporator module configured to incorporate a plurality of members into a virtual collective by storing voluntarily uploaded personal information for each member in computer readable memory, the personal information comprising one or more of name, email address, phone number, and banking information; a receiver module configured to receive a payment request uploaded into computer readable memory from one member of the collective for an expense via a network; and a divider module configured to divide the expense pro rata among the members of the collective.

The system further comprises a prompter module configured to prompt electronically via the network each member of the collective to pay a pro rata share of the expense; a payer module configured to receive an electronic payment of a pro rata share from each of a plurality of the members of the collective; a maintainer module configured to maintain a running tally of payment amounts received from members of the collective; a notifier module configured to notify each member via the network of the collective of the gross total of collective payments received which are associated with the expense; and a reminder module configured to remind non-paying members of the user group to pay.

The system may also comprise a remitter module configured to remit all payments received and associated with the expense to the member uploading the payment request.

The system may additionally comprise a creator module configured to create a sub-collective comprising a plurality of the members, each of the members of the sub-collective associated with one of: a common commercial venture and a common recreational activity.

The network may comprise a wireless cellular network. Each of the members may be notified via one of computer terminal and a smart cellular phone.

The system may further comprise: an ad module configured to receive a classified ad from a member via an upload, the classified ad comprising one or more of a picture of a tangible good and contact information for the member, the contact information comprising one or more of name, email address, and telephone number; a provider module configured to provide a searchable database of all classified ads received by members; and a facilitator module configured to facilitate the transfer of money between the member uploading the classified ad and a purchaser.

The system may further comprise: an offer module configured to receive a discount offer via an upload from a member, the discount offer comprising one or more of an offer to sell a consumer good exclusively to members, the offer comprising a price that is less than a price charged to non-members, the price exclusively available to members; an allower module configured to allow members to purchase the consumer good for the price; and a money module configured to transfer money from a member buying the consumer good to a member responsible for the upload.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an entity-relationship diagram illustrating one embodiment of a system to perform operations for distributing expenses to commonly-acquainted members of a collective in accordance with the present invention;

FIG. 2 is an entity-relationship diagram illustrating one embodiment of a system to perform operations for distributing expenses to commonly-acquainted members of collective in accordance with the present invention;

FIG. 3 is a flowchart illustrating one method for distributing expenses to commonly-acquainted members of a collective in accordance with the present invention;

FIG. 4 is a block diagram illustrating components of one embodiment of an apparatus for distributing expenses to commonly-acquainted members of a collective; and

FIG. 6 is a layout of browser manipulated by one embodiment of the present invention for distributing expenses to commonly-acquainted members of a collective in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

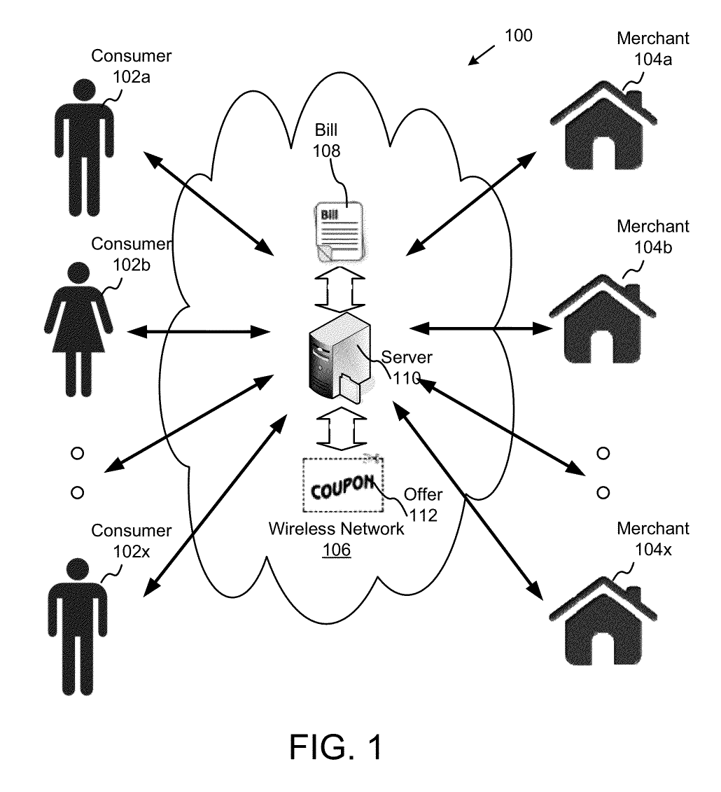

FIG. 1 is an entity-relationship diagram illustrating one embodiment of a system 100 to perform operations for distributing expenses to commonly-acquainted members of a collective in accordance with the present invention. The entities in the system 100 comprise consumers 102a-x, merchants 104a-x, a wireless network 106, a bill 108, and a server 110.

The server 110 comprises a system or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

The server 110, in the shown embodiment, comprises a database management system (DBMS) or relational database management system (RDBMS), such as Oracle, SQL, FireBird, IBM DB2®, or the like. In the shown embodiment, one or more individuals access or login to an account they have with the server 110. These individuals upload personal identifying information which they use to create an account with the server 110, which account membership information is stored in computer readable database memory accessible by server 110.

The personal identifying information is stored in a database; and comprises identifying information, such as name, address, email, telephone, IP address information, age, address, gender, banking information, credit rating, email, telephone number, income, and education.

In the present invention, the server 110 interconnects one or more members 102 and/or merchants 104 through means known to those of skill in the art, including a website accessible over a wireless network 106 such as the Internet.

The server 110 may, in typical embodiments, be in logical communication with consumers 102 through a networked environment, such as local area network (LAN) or wide area network (WAN).

Consumers 102, in some embodiments, may upload, or transfer, discount offers 112 and/or classified ads and/or money transfer orders to the server 110. The consumers 102 may make these uploading, or transfer these instructions, using means known to those of skill in the art, including variations of the Simple Mail Transfer Protocol (SMTP), Internet Message Access Protocol (IMAP), Post Office Protocol (POP), File Transfer Protocol (FTP), or other protocols.

The consumers 102 communicate using data processing devices (DPDs), which, in the preferred embodiment, comprise smart phones including iPhone, Android, Palm Pilots®, and the like. These DPDs may even comprise digital cameras or laptops, etc.

It is an object of the present invention to provide means for consumers 102 to share expenses incurred by a group (i.e. collective) of which they form part, which expenses are incurred by, or benefit, the collective as a whole. For instance, consumers belonging to a family unit vacationing out of town may wish to share expenses across the family unit. Likewise friends vacationing may wish to do the same. Co-owners of a home may wish to split a home payment, and tenants may wish to split a mortgage or lease payment, either pro rata or non-pro rata.

In accordance with the present invention, each of the members of a collective of commonly-acquainted consumers may pay only their share of an expense incurred by the collective using the method, system and computer program product recited below. In one embodiment, the computer program product (which comprises a computer readable medium having computer usable program code that is executable) performs operations for distributing expenses to a commonly-acquainted collective. The operations of the computer program product comprise, in some embodiments, incorporating a plurality of members into a virtual collective by storing voluntarily uploaded personal information for each member in computer readable memory, the personal information comprising one or more of name, email address, phone number, and banking information.

Consumers 102 become “incorporated” after registering with the server 110 and provided personal identifying information thereto, including one or more of name, email address, banking routing number, bank account number, IP address, and the like.

In the shown embodiments, once a consumer 102 has been incorporated by the server 110, the consumer 102 may be prompted to join of collective. Consumers 102 may search for collectives by name, or start a new collective and invite acquaintances by name to join. These acquaintances may comprise personal and professional acquaintances with whom the consumer 102 maintains personal and/or professional relationships. The consumer 102 is thus first incorporated, then joined into a collective, before being able to share expenses incurred by the collective.

Incorporated consumers 102 (i.e. members) are brought into social contact with one another. These incorporated consumers can chat with one another using means known to those of skill in the art. These members can message one another using email via means known to those of skill in the art, and these members can notify other members of their collective of special offers on tangible consumer goods for sale, and/or their willingness to pay expenses about to be incurred by the collective via the actions of one or members of the collective.

In various embodiments, before incurring an expense for the collective, members may upload a price and description of an expense about to be incurred. In some embodiments, these members also upload an estimated date, or durations of time, upon which the expense will be incurred.

In various embodiments, the members of the collective then indicate their willingness to pay a share of this expense by pressing a virtual button on a smart phone or other DPD in communication with the server 110. In various embodiments, members who not indicate either a willingness to accept responsibility for the expense, or not to accept responsibility for the expense, are deemed by the server 110 to have consented or non-consented to the expense in accordance with either setting configured by an administrator or default settings saved in computer readable memory.

In various embodiments, the consumer 102 is prompted whenever an expense is uploaded a member of that consumer's 102 collective to pay a pro rata share. In other embodiments, each consumer 102 in the collective is exclusively assigned by the creator of the collective a pay percentage value, which comprises a value identifying the percentage of each expense for which each respective consumer 102 is responsible.

The server 110 may divide up a bill uploaded for payment by the collective into smaller bills which are tendered to each member of the collective. These smaller bills may consist of payment amounts determined in accordance with each consumer's 102 pay percentage value, or may consist of a pro rated expense based on the number of consumers 102 in the collective.

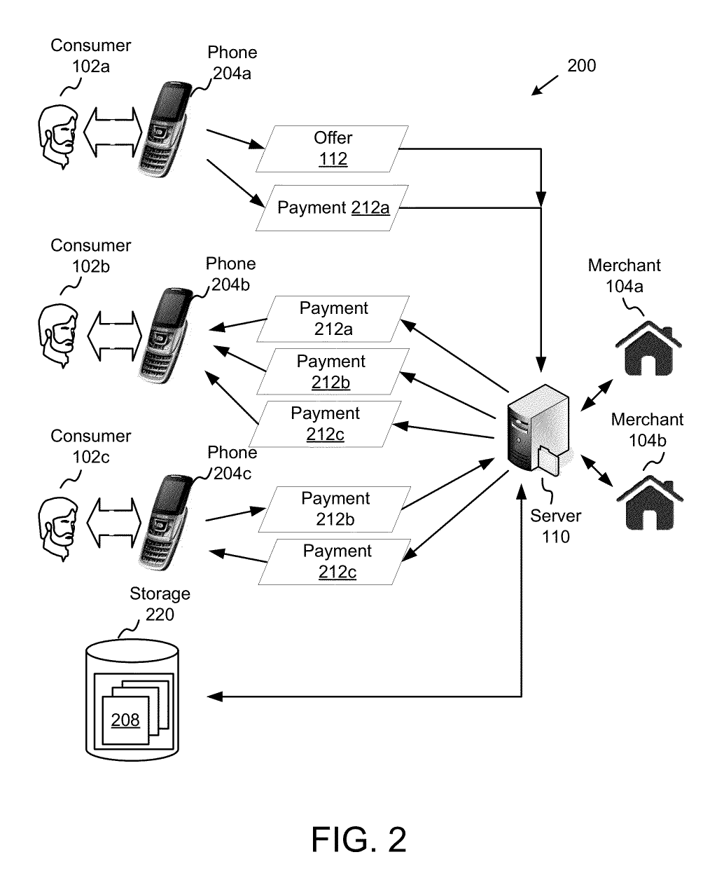

FIG. 2 is an entity-relationship diagram illustrating one embodiment of a system 200 to perform operations for distributing expenses to commonly-acquainted members of collective in accordance with the present invention. The system 200 comprises merchants 102a-c, phones 204a-c, an offer 210a, a payment 212a, a payments 212b, a payment 212c, and computer readable storage 220 comprising computer readable database records 208.

In the shown embodiment, merchants 104a-b, using DPDs, are in logical communication via a network with the server 110 and consumers 102a-c. Merchants 104 may likewise be incorporated by the server 110. The merchants 104 may comprise any individual, company or organization attempting to retail, sale, or market goods or services to consumers 102.

These consumers communicate with the server 110, in the shown embodiment, using smart cellular phones 204a-c. Using these phone 204a-c, the consumers 102a-c remit payments 212a-c to the server 110. In the shown embodiment, the server than remits, or reimburses, these payments 212a-c, to consumer 102b, who, in this embodiment, paid an original bill 108 for the collective.

Likewise, consumers 102 and merchants 104 may remit offers 112 to the server 110. These offers may comprise offers on new or used goods, which are offered with exclusively to the members of the collective, or to all incorporated consumers 102.

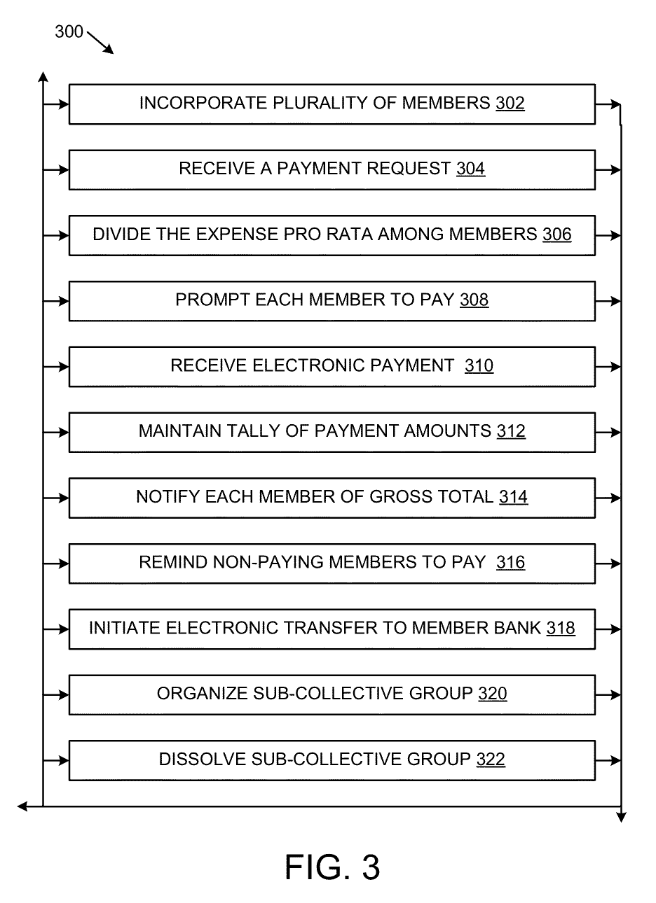

FIG. 3 is a flowchart illustrating one method 300 for distributing expenses to commonly-acquainted members of a collective in accordance with the present invention. The method 300 begins when individuals are incorporated 302 as members into the virtual collective.

Bills 108 (i.e. payment requests), are received uploaded into computer readable memory from one member of the collective for an expense via a network. Expenses are divided pro rata among the members of the collective.

Each member is prompted electronically via the network each member of the collective to pay a pro rata share of the expense; and the server 110 then receives an electronic payment of a pro rata share from each of a plurality of the members of the collective; while maintaining a running tally of payment amounts received from members of the collective. The server 110 may also notify each member via the network of the collective of the gross total of collective payments received which are associated with the expense; and remind non-paying members of the user group to pay.

In various embodiments, the server 110 maintains virtual bank accounts exclusively associated with each member of the collective. These bank accounts contain a balance of virtual dollars, each virtual dollar exclusively corresponding to an actual dollar in a real bank account maintained by an administrator of the server 110.

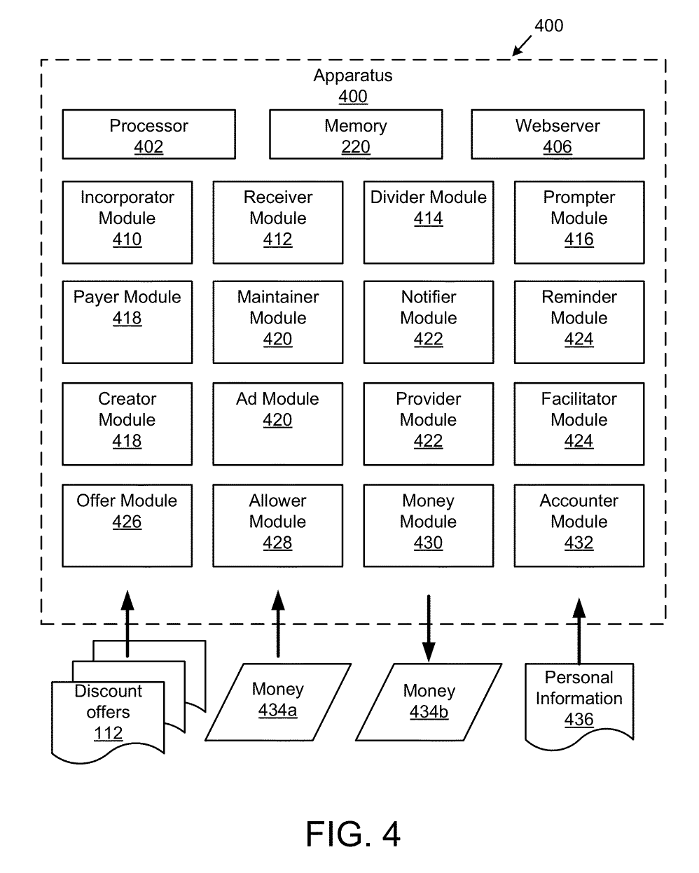

FIG. 4 is a block diagram illustrating components of one embodiment of an apparatus 400 for distributing expenses to commonly-acquainted members of a collective. The apparatus 400 comprises processor 402, a computer readable storage 220, webserver 406, an incorporator module 410, a receiver module 412, a divider module 414, a prompter module 416, a payer module 418, a maintainer module 420, a notifier module 422, a reminder module 424, a creator module 418, an ad module 420, a provider module 422, a facilitator module 424, an offer module 426, an allower module 428, a money module 430, and an accounter module 432, money 324a, money 434b, a discount offer 124, and personal information 436.

FIG. 4 may equally as well show a system embodiment of the present invention. Each of the modules, or components, of apparatus 400 may also comprise modules of a corresponding system.

The modules substantially perform the functions ascribed to method steps disclosed hereinabove and below. In the shown embodiment, discount offers 112 are uploaded into the system or apparatus 400. Money 434a, or instructions to route money, are also uploaded by members of the collective into the apparatus 400, while aggregated money payments 434b may be sent from the system or apparatus 400 to members of the collective who have paid for goods.

Likewise, when consumers 102 are incorporated by the system or apparatus 400, they upload personal information 436 to the server 110.

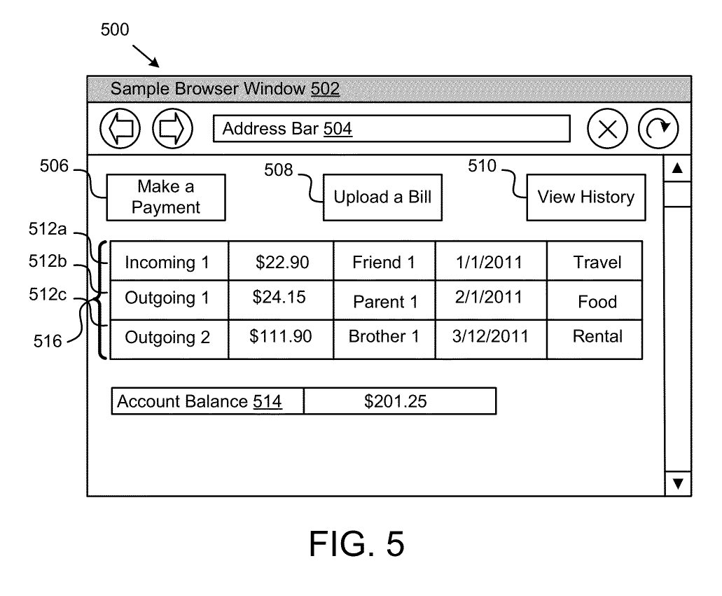

FIG. 6 is a layout of browser manipulated by one embodiment of the present invention for distributing expenses to commonly-acquainted members of a collective in accordance with the present invention.

The parents 104a-b and/or child 106 interface with the central managing forum 102 through the stations 108a-c.

The functions of the systems shown in the present invention correspond generally to other systems, methods, apparatii and computer program products outlined in the present invention, and further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code executable to perform operations for distributing expenses to a commonly-acquainted collective, the operations of the computer program product comprising:
incorporating a plurality of members into a virtual collective by storing voluntarily uploaded personal information for each member in computer readable memory, the personal information comprising one or more of name, email address, phone number, and banking information;
receiving a payment request via a network uploaded into computer readable memory from one member of the collective for an expense incurred for the benefit of the collective;
dividing the expense pro rata among the members of the collective;
prompting electronically via the network each member of the collective to pay a pro rata share of the expense;
receiving an electronic payment of a pro rata share from each of a plurality of the members of the collective;
maintaining a running tally of payment amounts received from members of the collective;
notifying each member via the network of the collective of the gross total of collective payments received which are associated with the expense; and
reminding non-paying members of the user group to pay.

2. The computer program product of claim 1, further comprising remitting all payments received and associated with the expense to the member uploading the payment request.

3. The computer program product of claim 1, further comprising maintaining a banking account balance for each member of the collective, the balance exclusively accessible by a member of the collective associated with the balance.

4. The computer program product of claim 1, further comprising creating a sub-collective comprising a plurality of the members, each of the members of the sub-collective associated with one of: a common commercial venture and a common recreational activity.

5. The computer program product of claim 1, wherein the network comprises a wireless cellular network.

6. The computer program product of claim 1, wherein each of the members are notified via one of computer terminal and a smart cellular phone.

7. The computer program product of claim 1, further comprising:
receiving a classified ad from a member via an upload, the classified ad comprising one or more of a picture of a tangible good and contact information for the member, the contact information comprising one or more of name, email address, and telephone number;
providing a searchable database of all classified ads received by members; and
facilitating the transfer of money between the member uploading the classified ad and a purchaser.

8. The computer program product of claim 1, further comprising:
receiving a discount offer via an upload from a member, the discount offer comprising one or more of an offer to sell a consumer good exclusively to members, the offer comprising a price that is less than a price charged to non-members, the price exclusively available to members;
allowing members to purchase the consumer good for the price; and
transferring money from a member buying the consumer good to a member responsible for the upload.

9. The computer program product of claim 1, wherein each of the members is assigned a pay percentage value, the pay percentage value identifying the percentage of the expense for which each respective member is responsible.

10. A system to perform operations for distributing expenses to a commonly-acquainted collective, the system comprising:
a processor;
a data storage means for storing data;
an incorporator module configured to incorporate a plurality of members into a virtual collective by storing voluntarily uploaded personal information for each member in computer readable memory, the personal information comprising one or more of name, email address, phone number, and banking information;
a receiver module configured to receive a payment request uploaded into computer readable memory from one member of the collective for an expense via a network;
a divider module configured to divide the expense pro rata among the members of the collective;
a prompter module configured to prompt electronically via the network each member of the collective to pay a pro rata share of the expense;
a payer module configured to receive an electronic payment of a pro rata share from each of a plurality of the members of the collective;
a maintainer module configured to maintain a running tally of payment amounts received from members of the collective;
a notifier module configured to notify each member via the network of the collective of the gross total of collective payments received which are associated with the expense; and
a reminder module configured to remind non-paying members of the user group to pay.

11. The system of claim 9, further comprising a remitter module configured to remit all payments received and associated with the expense to the member uploading the payment request.

12. The system of claim 9, further comprising a creator module configured to create a sub-collective comprising a plurality of the members, each of the members of the sub-collective associated with one of: a common commercial venture and a common recreational activity.

13. The system of claim 9, wherein the network comprises a wireless cellular network.

14. The system of claim 9, wherein each of the members are notified via one of computer terminal and a smart cellular phone.

15. The system of claim 9, further comprising:
an ad module configured to receive a classified ad from a member via an upload, the classified ad comprising one or more of a picture of a tangible good and contact information for the member, the contact information comprising one or more of name, email address, and telephone number;
a provider module configured to provide a searchable database of all classified ads received by members; and
a facilitator module configured to facilitate the transfer of money between the member uploading the classified ad and a purchaser.

16. The system of claim 9, further comprising:
an offer module configured to receive a discount offer via an upload from a member, the discount offer comprising one or more of an offer to sell a consumer good exclusively to members, the offer comprising a price that is less than a price charged to non-members, the price exclusively available to members;
an allower module configured to allow members to purchase the consumer good for the price; and
a money module configured to transfer money from a member buying the consumer good to a member responsible for the upload.
